(19) United States
(12) Patent Application Publication
(10) Pub. No.: US 2008/0140907 A1
(43) Pub. Date: Jun. 12, 2008

(54) Multimodal Memory Controllers

(76) Inventors: Daniel M. Dreps, Georgetown, TX (US); Bradley D. McCredie, Austin, TX (US)

Correspondence Address: IBM (ROC-BLF), C/O BIGGERS & OHANIAN, LLP, P.O. BOX 1469, AUSTIN, TX, 78767-1469, US

(21) Appl. No.: 11/567,549

(22) Filed: Dec. 6, 2006

(51) Int. Cl. G06F 12/00

(52) U.S. Cl. 711/100; 711/E12.001

(57) ABSTRACT

Multimodal memory controllers are disclosed that include: a transceiver circuit having at least one internal signal line, a first external signal line, a second external signal line, and a mode control signal line, the mode control signal line having asserted upon it a mode control signal, and the transceiver circuit configured to operate the external signal lines for single-ended signaling at a first voltage when the mode control signal is a first value and to operate the external signal lines for differential signaling at a second voltage when the mode control signal is a second value.

### BACKGROUND OF THE INVENTION

1. Field of the Invention

The field of the invention is data processing, or, more specifically, multimodal memory controllers and methods for multimodal operation of a memory controller.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

As computing systems have evolved, at least two different computer memory bus architectures have emerged. On very low end computers, system designers integrate a memory controller directly into a system processor to access one or more channels of Dual In-line Memory Modules (‘DIMMs’) through a computer memory bus that implements a parallel, single-ended signaling protocol. Single-ended signaling is a method of transmitting electrical signals over a single signal line that is interpreted using a reference voltage. An advantage of single-ended signaling is the number of wires needed to transmit multiple signals simultaneously. If a bus needs to transmit n signals, then the bus needs to have at least n+1 signal lines—one for each signal, plus one for a ground. The main disadvantage of single-ended signaling is that the return currents for all the signals share the same wire and can sometimes cause interference, or crosstalk, between the signals. Such crosstalk typically limits the bandwidth of single-ended signaling systems. Examples of a parallel, single-ended signaling protocol may include Double Data Rate (‘DDR’) two or DDR three. A computer bus that implements DDR2 uses 64 data lanes to transfer data at a maximum rate of 800 megabits per second and has a power supply rail voltage of 1.8 volts. A computer bus that implements DDR3 also uses 64 data lanes, but transfers data at a maximum rate of 1600 megabits per second and has a power supply voltage rail of 1.5 volts.

On higher end computer systems that require increased bandwidth, system designers configure a memory controller to access a memory buffer through a computer memory bus that implements a serial, differential signaling protocol. Differential signaling is a method of transmitting electrical signals over a pair of signal lines such that the sum of the voltages for the signals on the pair of signal lines remains constant. Differential signaling reduces the noise on a connection by rejecting common-mode interference. The pair of signal lines are routed in parallel, and sometimes twisted together, so that they will receive the same interference. One wire carries the signal, and the other wire carries the inverse of the signal. At the end of the connection, instead of reading a single signal, the receiving device reads the difference between the two signals. Because the receiver ignores the wires' voltages with respect to ground, small changes in ground potential between transmitter and receiver do not affect the receiver's ability to detect the signal. Furthermore, the system is immune to most types of electrical interference because any disturbance that alters the voltage level on one signal line will correspondently alter the voltage on the other signal line. Examples of a serial, differential signaling protocol may include a protocol according to the Fully Buffered DIMM one (‘FBDIMM1’) specification and the future Fully Buffered DIMM two (‘FBDIMM2’) specification. The computer bus that implements the FBDIMM1 technology uses 24 data lanes per channel to transfer data at 4.8 gigabits per second and has a power supply rail of 1.5 or 1.2 volts. FBDIMM2 is specified to transfer data up to 9.6 gigabits per second with the same 24 lanes in the future. The memory buffer, in turn, accesses the DIMMs through one or more channels using lower bandwidth computer buses implementing a protocol such as, for example, DDR2 or DDR3.

The drawback to having these two computer memory bus architectures is that system designers must design and manufacture memory controllers with separate physical interfaces—one physical interface to drive a computer memory bus that implements a parallel, single-ended signaling protocol, and another physical interface to drive a computer memory bus that implements a serial, differential signaling protocol. As such, system designers must also design and manufacture separate sockets into which the memory controllers connect to a motherboard for each architecture. When the memory controller is integrated into the computer processor, separate computer processor must also be designed and manufactured for each architecture. Designing and manufacturing each of these separate components for the two architectures is time-consuming and costly. Readers will therefore appreciate that there is an ongoing need for innovation in the field of memory systems and, in particular, memory controllers.

### SUMMARY OF THE INVENTION

Multimodal memory controllers are disclosed that include: a transceiver circuit having at least one internal signal line, a first external signal line, a second external signal line, and a mode control signal line, the mode control signal line having asserted upon it a mode control signal, and the transceiver circuit configured to operate the external signal lines for single-ended signaling at a first voltage when the mode control signal is a first value and to operate the external signal lines for differential signaling at a second voltage when the mode control signal is a second value.

Methods of multimodal operation of a memory controller are disclosed that include: receiving, in a transceiver circuit of a memory controller, a mode control signal, the transceiver circuit having at least one internal signal line, a first external signal line, and a second external signal line; detecting, by the transceiver circuit, whether the mode control signal is a first value or a second value; operating, by the transceiver circuit, the external signal lines for single-ended signaling at a first voltage if the mode control signal is a first value; and operating, by the transceiver circuit, the external signal lines for differential signaling at a second voltage if the mode control signal is a second value.

Methods of multimodal operation of a memory controller are also disclosed that include: providing a transceiver circuit in a memory controller, the transceiver circuit having at least one internal signal line, a first external signal line, a second external signal line, and a mode control signal line, the mode control signal line having asserted upon it a mode control signal; configuring the transceiver circuit to operate the external signal lines for single-ended signaling at a first voltage when the mode control signal is a first value; and configuring the transceiver circuit to operate the external signal lines for differential signaling at a second voltage when the mode control signal is a second value.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery that includes an exemplary multimodal memory controller according to embodiments of the present invention.

FIG. 2 sets forth a block diagram of automated computing machinery that includes a further exemplary multimodal memory controller according to embodiments of the present invention.

FIG. 3 sets forth a schematic diagram of an exemplary multimodal memory controller according to embodiments of the present invention.

FIG. 4 sets forth a schematic diagram of a further exemplary multimodal memory controller according to embodiments of the present invention.

FIG. 5 sets forth a schematic diagram of a further exemplary multimodal memory controller according to embodiments of the present invention.

FIG. 6 sets forth a flow chart illustrating an exemplary method of multimodal operation of a memory controller according to embodiments of the present invention.

FIG. 7 sets forth a flow chart illustrating a further exemplary method of multimodal operation of a memory controller according to embodiments of the present invention.

FIG. 8 sets forth a flow chart illustrating a further exemplary method of multimodal operation of a memory controller according to embodiments of the present invention.

### DETAILED DESCRIPTION OF EXEMPLARY EMBODIMENTS

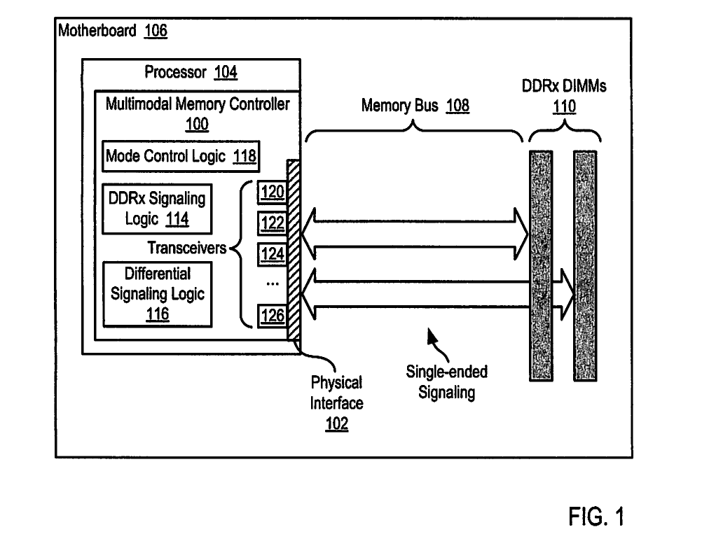

Exemplary multimodal memory controllers and exemplary methods for multimodal operation of a memory controller in accordance with the present invention are described with reference to the accompanying drawings, beginning with FIG. 1. FIG. 1 sets forth a block diagram of automated computing machinery that includes an exemplary multimodal memory controller (100) according to embodiments of the present invention. The multimodal memory controller (100) of FIG. 1 is integrated into a computer processor (104) installed on motherboard (106). Although the multimodal memory controller (100) of FIG. 1 is integrated in the processor (104), readers will note that such an implementation is for explanation and not for limitation. In fact, multimodal memory controllers according to embodiments of the present invention may be implemented as a standalone semiconductor device that connect to a system processor, as part of a bus adapter such as, for example, the Intel Northbridge, or any other implantation as will occur to those of skill in the art.

The multimodal memory controller (100) of FIG. 1 includes transceiver circuits (120, 122, 124, 126). A transceiver circuit is an electronic circuit that operates to transmit electronic signals to and receive electronic signals from other electronic components in a computer system. Each transceiver circuit (120, 122, 124, 126) of FIG. 1 has at least one internal signal line, a first external signal line, and a second external signal line. An internal signal line is a conductive pathway for carrying data communication signals between a transceiver circuit and other components inside the memory controller (100) such as, for example, signaling logic. An external signal line is a conductive pathway for carrying data communication signals between a transceiver circuit and a component outside the memory controller such as, for example, a memory module or a memory buffer. Each transceiver circuit (120, 122, 124, 126) of FIG. 1 utilizes its first and second signal lines to transmit two streams of bits when the transceiver operates the external signal lines for single-ended signaling at a first voltage. When the transceiver operates the external signal lines for differential signaling at a second voltage, each transceiver circuit (120, 122, 124, 126) of FIG. 1 utilizes its first and second signal lines to transmit a single stream of bits on the pair of external signal lines.

In the example of FIG. 1, each transceiver (120, 122, 124, 126) in the exemplary multimodal memory controller (100) of FIG. 1 also includes a mode control signal line having asserted upon it a mode control signal. The model control signal line is a conductive pathway that connects a transceiver to mode control logic (118). The mode control logic (118) is an electronic circuit for generating a mode control signal according to hardware configuration into which the memory controller is installed. A system designer may specify the value of the mode control signal generated by the mode control logic (118) using Dual In-line Package (‘DIP’) switches, jumper blocks, Basic Input/Output System (‘BIOS’) instructions, or in other manner as will occur to those of skill of the art.

When the memory controller is installed by a system designer into a low end computer system in which the memory controller communicates directly with the DIMMs, the system designer may configure the mode control logic (118) of FIG. 1 to generate a first value, such as logical zero, for the mode control signal. In such an exemplary hardware configuration, a transceiver circuit may operate the external signal lines for single-ended signaling at 1.8 or 1.5 volts according to the DDR2 or DDR3 protocols, respectively. When the memory controller is installed by a system designer into a higher performance computer system in which the memory controller communicates directly with a memory buffer, the system designer may configure the mode control logic (118) of FIG. 1 to generate a second value, such as logical one, for the mode control signal. In such an exemplary hardware configuration, a transceiver circuit may operate the external signal lines for differential signaling at, for example, 1.5 or 1.2 volts according to the FBDIMM protocol. In such a manner, each transceiver circuit (120, 122, 124, 126) is configured to operate the external signal lines for single-ended signaling at a first voltage when the mode control signal is a first value and is configured to operate the external signal lines for differential signaling at a second voltage when the mode control signal is a second value.

The external signal lines of each transceiver circuit (120, 122, 124, 126) in the exemplary memory controller (100) of FIG. 1 connect to a physical interface (102). The physical interface (102) of FIG. 1 is a set of pins provided by the memory controller (100) that connect directly to the motherboard (106) or, as typically occurs, indirectly through a socket installed on the motherboard (106). Because each transceiver circuit (120, 122, 124, 126) is configured to operate the external signal lines for single-ended signaling at a first voltage and for differential signaling at a second voltage, the physical interface (102) may advantageously connect the memory controller (100) to a computer memory bus that implements either a parallel, single-ended signaling protocol such as, for example, DDR2 or DDR3, or a serial, packetized, differential signaling protocol such as, for example, FBDIMM.

To provide electronic signals according to a signal-ended signaling protocol, the exemplary memory controller (100) includes DDRx signaling logic (114). The DDRx signaling logic (114) of FIG. 1 is an electronic circuit that generates and interprets electronic signals according to a DDR protocol such as, for example, DDR2, DDR3, or any future DDR protocol. The DDRx signaling logic (114) of FIG. 1 connects to each transceiver circuit (120, 122, 124, 126) through the internal signal lines of each transceiver circuit (120, 122, 124, 126).

To provide electronic signals according to a differential signaling protocol, the exemplary memory controller (100) includes differential signaling logic (116). The differential signaling logic (116) of FIG. 1 is an electronic circuit that generates and interprets electronic signals according to a packetized, serial protocol such as, for example, the FBDIMM protocol. The differential signaling logic (116) of FIG. 1 connects to each transceiver circuit (120, 122, 124, 126) through the internal signal lines of each transceiver circuit (120, 122, 124, 126).

In the example of FIG. 1, the motherboard (106) onto which the memory controller (100) is installed includes a memory bus (108) that directly connects the memory controller (100) to DDRx DIMMs (110). The memory bus (108) is a set of parallel conductive pathways that conduct electronic signals at very high frequencies, often in excess of a gigahertz, between the memory controller (100) and the DDRx DIMMs (110). DDRx DIMMs (110) are DIMMs implemented according to the DDR family of specifications such as, for example, DDR2, DDR3, and any future DDR specifications. The memory bus (108) of FIG. 1 may form a point-to-point connection or multi-drop connections between the memory controller (100) and each of the DDRx DIMMs (110). Because the motherboard (106) of FIG. 1 directly connects the memory controller (100) to DDRx DIMMs (110), a system designer configures the mode control logic (118) of FIG. 1 to assert a mode control signal having a first value. Each of the transceiver circuits (120, 122, 124, 126), therefore, operates the external signal lines that connect to the memory bus (108) for single-ended signaling. In the example of FIG. 1, each of the transceiver circuits (120, 122, 124, 126) operates the external signal lines according to a Double Data Rate protocol such as, for example, DDR2 or DDR3.

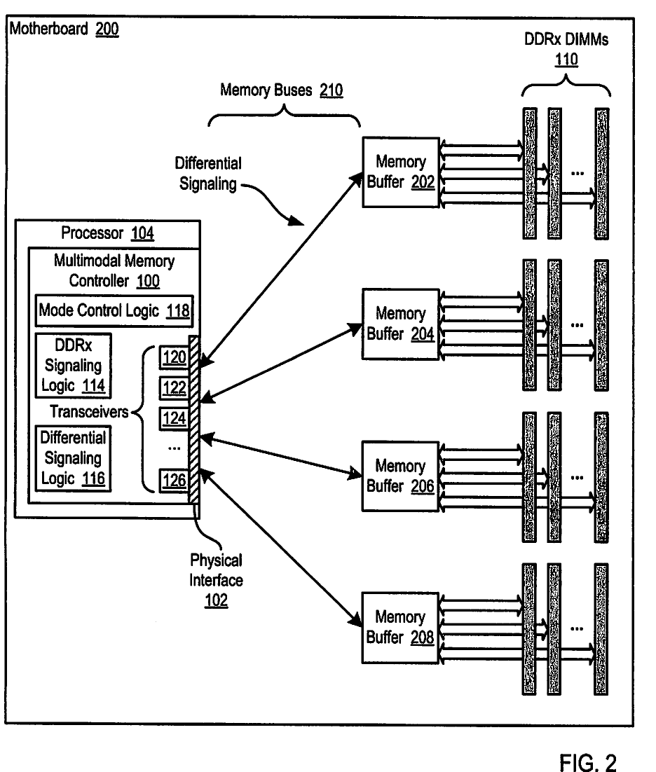

As mentioned above, a transceiver circuit in a multimodal memory controller according to embodiments of the present invention may operate external signal lines for either single-ended signaling at a first voltage or differential signaling at a second voltage. FIG. 1 illustrates a transceiver circuit that operates external signal lines for single-ended signaling at a first voltage. For further explanation, FIG. 2 sets forth a block diagram of automated computing machinery that includes a further exemplary multimodal memory controller (100) according to embodiments of the present invention in which a transceiver operates external signal line for differential signaling at a second voltage.

The multimodal memory controller (100) of FIG. 2 is the same as the multimodal memory controller (100) of FIG. 1. The multimodal memory controller (100) of FIG. 2 is installed in a processor (104) and includes transceiver circuits (120, 122, 124, 126). Each transceiver circuit (120, 122, 124, 126) of FIG. 2 has at least one internal signal line, a first external signal line, and a second external signal line. The internal signal lines of each transceiver circuit (120, 122, 124, 126) connect to the DDRx signaling logic (114) and the differential signaling logic (116). The external signal lines connect to memory buses (210) through a physical interface (102).

Each transceiver circuit (120, 122, 124, 126) of FIG. 2 also has a mode control signal line that connects each transceiver to a mode control logic (118). The mode control logic (118) asserts a mode control signal upon the mode control signal line. Each transceiver circuit (120, 122, 124, 126) of FIG. 2 is configured to operate the external signal lines for single-ended signaling at a first voltage when the mode control signal is a first value and configured to operate the external signal lines for differential signaling at a second voltage when the mode control signal is a second value.

In example of FIG. 2, the multimodal memory controller (100) is installed on a motherboard (200) that connects the memory controller (100) to memory buffers (202, 204, 206, 208) through memory buses (210). Each memory buffer (202, 204, 206, 208) of FIG. 2 receives access requests from the multimodal memory controller (100) and fulfills the request by retrieving data from or writing data to DDRx DIMMs (110). Each memory buffer (202, 204, 206, 208) stores unfulfilled requests from the memory controller (100) until the memory buffer is able to satisfy the request. Similarly, each memory buffer (202, 204, 206, 208) stores retrieved data for transmission to the memory controller (100) until the memory bus (210) for the memory buffer has available bandwidth to transmit the retrieved data to the memory controller (100).

As mentioned above, the motherboard (200) of FIG. 2 connects the memory controller (100) to memory buffers (202, 204, 206, 208). In such a hardware environment, a system designer configures the mode control logic (118) of FIG. 2 to assert a mode control signal having a second value—as opposed to asserting a mode control signal having a first value as described with reference to FIG. 1. Each of the transceiver circuits (120, 122, 124, 126), therefore, operates the external signal lines that connect to the memory buses (210) for differential signaling. In the example of FIG. 2, each of the transceiver circuits (120, 122, 124, 126) operates the external signal lines according to a packetized, serial protocol such as, for example, the FBDIMM protocol.

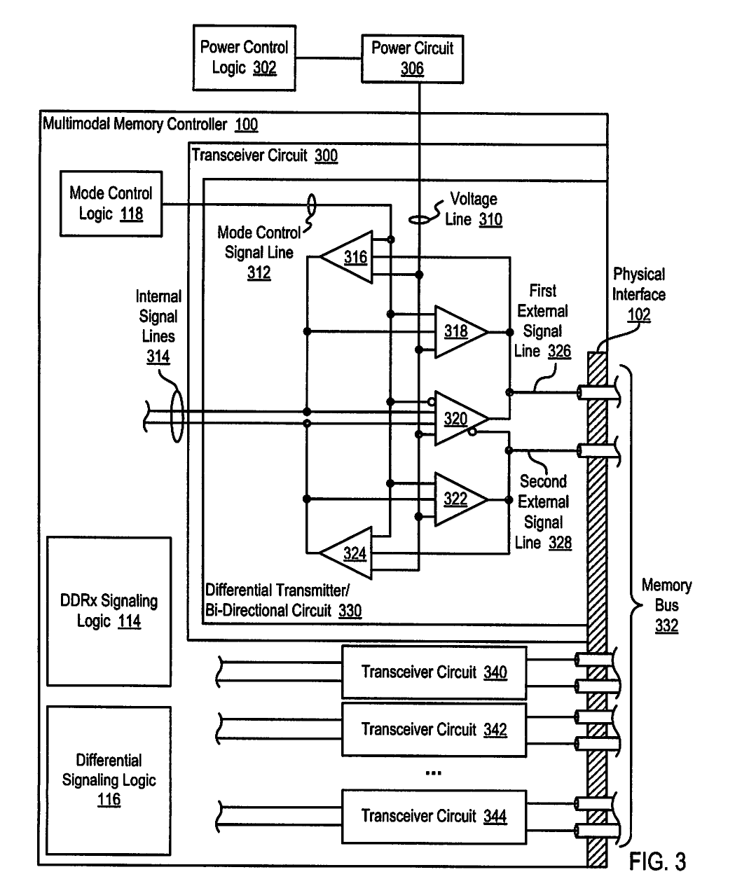

To transmit signal through the two computer memory bus implementations illustrated in FIGS. 1 and 2, each transceiver circuit of a multimodal memory controller operates its external signal lines for single-ended signaling and differential signaling. When operating the external signal lines for single-ended signaling, a transceiver typically utilizes the external signal lines for bi-directional data communications. When operating the external signal lines for differential signaling, a transceiver typically utilizes the external signal lines for uni-directional data communications. To perform bi-directional data communications while operating the external signal lines for single-ended signaling and to perform uni-directional data communication while operating external signal lines for differential signaling, a multimode memory controller may include a differential transmitter/bi-directional circuit. For further explanation, therefore, FIG. 3 sets forth a schematic diagram of an exemplary multimodal memory controller (100) according to embodiments of the present invention that includes a differential transmitter/bi-directional circuit (330).

In the example of FIG. 3, the exemplary multimodal memory controller (100) of FIG. 3 includes transceiver circuits (300, 340, 342, 344). Each transceiver circuit connects to a memory bus (332) through a physical interface (102). The memory bus (332) of FIG. 3 may be implemented using either a parallel, single-ended protocol such as, for example, DDR2 protocol or DDR3 protocol, or a serial, differential protocol such as, for example, the FBDIMM protocol because the multimodal memory controller may be configured to operate in either hardware environment.

The transceiver circuit (300) of FIG. 3 has internal signal lines (314), a first external signal line (326), and a second external signal line (328). The internal signal lines (314) connect to DDRx signaling logic (114) and differential signaling logic (116). The external signal lines (326, 328) connect to the memory bus (332) through physical interface (102).

In the example of FIG. 3, the transceiver circuit (300) includes a differential transmitter/bi-directional circuit (330). The differential transmitter/bi-directional circuit (330) of FIG. 3 has a differential transmitter (320), a first single-ended driver (318), a second single-ended driver (322), a first single-ended receiver (316), and a second single-ended receiver (324). The first single-ended driver (318) and the first single-ended receiver (316) connect to the first external signal line (326) and connect to one of the internal signal lines (314). The second single-ended driver (322) and the second single-ended receiver (324) connect to the second external signal line (328) and connect to the other internal signal line (314). The differential transmitter (320) of FIG. 3 connects to both of the external signal lines (326, 328) and connects to both internal signal lines (314).

To control whether the transceiver circuit (300) operates the external signal lines (326, 328) for single-ended signaling or operates the external signal lines (326, 328) for differential signaling, the transceiver circuit (300) has a mode control signal line (312). The mode control signal line (312) of FIG. 3 connects mode control logic (118) to enable inputs for the differential transmitter (320), the first single-ended driver (318), the second single-ended driver (322), the first single-ended receiver (316), and the second single-ended receiver (324). The mode control logic (118) of FIG. 3 asserts a mode control signal upon the mode control signal line (312). In the example of FIG. 3, the mode control signal is a binary signal that conveys either a logical one or logical zero to the components of the differential transmitter/bi-directional circuit (330). Because the enable input for the differential transmitter (320) complements the mode control signal, the differential transmitter (320) is disabled while the first single-ended driver (318), the second single-ended driver (322), the first single-ended receiver (316), and the second single-ended receiver (324) are enabled. Similarly, when the differential transmitter (320) is enabled, the first single-ended driver (318), the second single-ended driver (322), the first single-ended receiver (316), and the second single-ended receiver (324) are disabled. Circuitry within each of the components (316, 318, 320, 322, 324) of the differential transmitter/bi-directional circuit (330) may disable the component by increasing the impedance of the component to a relatively high value compared to other enabled components, using transistor gates to isolate the disabled component, or in any other manner as will occur to those of skill in the art.

The example of FIG. 3 also includes a power circuit (306). The power circuit (306) of FIG. 3 is an electronic circuit that provides power to the components of the transceiver circuit (300) at a plurality of voltages. In the example of FIG. 3, a voltage line (310) provides power at either a first voltage or a second voltage from the power circuit (306) to the first single-ended driver (318), the second single-ended driver (322), the first single-ended receiver (316), the second single-ended receiver (324), and the differential transmitter (320). Using such a voltage configuration along with the configuration of the mode control signal line (312), the transceiver circuit (300) of FIG. 3 is configured to operate the external signal lines (326, 328) for single-ended signaling at a first voltage when the mode control signal is a first value and to operate the external signal lines (326, 328) for differential signaling at a second voltage when the mode control signal is a second value. For example, the transceiver circuit (300) may be configured to operate the external signal lines (326, 328) according to a DDR protocol at 1.8 volts when the mode control signal is logical one and configured to operate the external signal lines (326, 328) according to a packetized, serial protocol at 1.2 volts when the mode control signal is logical zero. Regardless, therefore, of whether the memory bus (332) implements a bus protocol requiring single-ended signaling or differential signaling, the multimodal memory controller is advantageously configured to operate in either mode.

To control the voltages supplied by the power circuit (306), the example of FIG. 3 also includes power control logic (302) connected to the power circuit (306). A system designer may configure the power control logic (302) in a manner similar to the mode control logic (118). That is, a system designer may configure the power control logic (302) using DIP switches, jumper blocks, BIOS instructions, or in other manner as will occur to those of skill of the art.

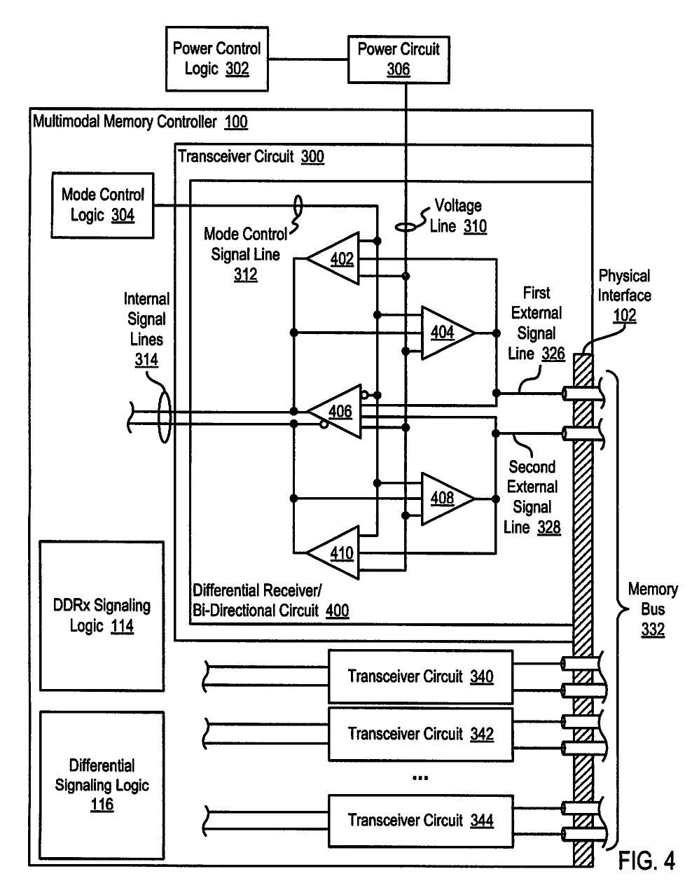

As mentioned above, when operating the external signal lines for single-ended signaling, a transceiver typically utilizes the external signal lines for bi-directional data communications. When operating the external signal lines for differential signaling, a transceiver typically utilizes the external signal lines for uni-directional data communications. To perform bi-directional data communications while operating the external signal lines for single-ended signaling and to perform uni-directional data communication while operating external signal lines for differential signaling, a multimode memory controller may include a differential transmitter/bi-directional circuit as described above with reference to FIG. 3. To perform bi-directional data communications while operating the external signal lines for single-ended signaling and to perform uni-directional data communication while operating external signal lines for differential signaling, a multimode memory controller may also include a differential receiver/bi-directional circuit. For further explanation, therefore, FIG. 4 sets forth a schematic diagram of a further exemplary multimodal memory controller (100) according to embodiments of the present invention that includes a differential receiver/bi-directional circuit (400).

The multimodal memory controller (100) of FIG. 4 is similar to the multimodal memory controller (100) of FIG. 3. The multimodal memory controller (100) of FIG. 4 includes transceiver circuits (300, 340, 342, 344). Each transceiver circuit connects to a memory bus (332) through a physical interface (102). The transceiver circuit (300) of FIG. 4 has internal signal lines (314), a first external signal line (326), and a second external signal line (328). The internal signal lines (314) connect to DDRx signaling logic (114) and differential signaling logic (116). The external signal lines (326, 328) connect to the memory bus (332) through physical interface (102).

In the example of FIG. 4, the transceiver circuit (300) includes a differential receiver/bi-directional circuit (400). The differential receiver/bi-directional circuit (400) of FIG. 4 has a differential receiver (406), a first single-ended driver (404), a second single-ended driver (408), a first single-ended receiver (402), and a second single-ended receiver (410). The first single-ended driver (404) and the first single-ended receiver (402) connect to the first external signal line (326) and connect to one of the internal signal lines (314). The second single-ended driver (408) and the second single-ended receiver (410) connect to the second external signal line (328) and connect to the other internal signal line (314). The differential receiver (406) of FIG. 4 connects to both of the external signal lines (326, 328) and connects to both internal signal lines (314).

To control whether the transceiver circuit (300) operates the external signal lines (326, 328) for single-ended signaling or operates the external signal lines (326, 328) for differential signaling, the transceiver circuit (300) has a mode control signal line (312). The mode control signal line (312) of FIG. 4 connects mode control logic (118) to enable inputs for the differential receiver (406), the first single-ended driver (404), the second single-ended driver (408), the first single-ended receiver (402), and the second single-ended receiver (410). The mode control logic (118) of FIG. 4 asserts a mode control signal upon the mode control signal line (312). In the example of FIG. 4, the mode control signal is a binary signal that conveys either a logical one or logical zero to the components of the differential receiver/bi-directional circuit (400).

Because the enable input for the differential receiver (406) complements the mode control signal, the differential receiver (406) is disabled while the first single-ended driver (404), the second single-ended driver (408), the first single-ended receiver (402), and the second single-ended receiver (410) are enabled. Similarly, when the differential receiver (406) is enabled, the first single-ended driver (404), the second single-ended driver (408), the first single-ended receiver (402), and the second single-ended receiver (410) are disabled. Circuitry within each of the components (402, 404, 406, 408, 410) of the differential receiver/bi-directional circuit (400) may disable the component by increasing the impedance of the component to a relatively high value compared to other enabled components, using transistor gates to isolate the disabled component, or in any other manner as will occur to those of skill in the art.

Similar to the example of FIG. 3, the example of FIG. 4 includes a power circuit (306) connected to power control logic (302). The power circuit (306) of FIG. 4 is an electronic circuit that provides power to the components of the transceiver circuit (300) at a plurality of voltages. In the example of FIG. 4, a voltage line (310) provides power at either a first voltage or a second voltage from the power circuit (306) to the first single-ended driver (404), the second single-ended driver (408), the first single-ended receiver (402), the second single-ended receiver (410), and the differential receiver (406). Using such a voltage configuration along with the configuration of the mode control signal line (312), the transceiver circuit (300) of FIG. 4 is configured to operate the external signal lines (326, 328) for single-ended signaling at a first voltage when the mode control signal is a first value and to operate the external signal lines (326, 328) for differential signaling at a second voltage when the mode control signal is a second value. For example, the transceiver circuit (300) may be configured to operate the external signal lines (326, 328) according to a DDR protocol at 1.8 volts when the mode control signal is logical one and configured to operate the external signal lines (326, 328) according to a packetized, serial protocol at 1.2 volts when the mode control signal is logical zero. Regardless, therefore, of whether the memory bus (332) implements a bus protocol requiring single-ended signaling or differential signaling, the multimodal memory controller is advantageously configured to operate in either mode.

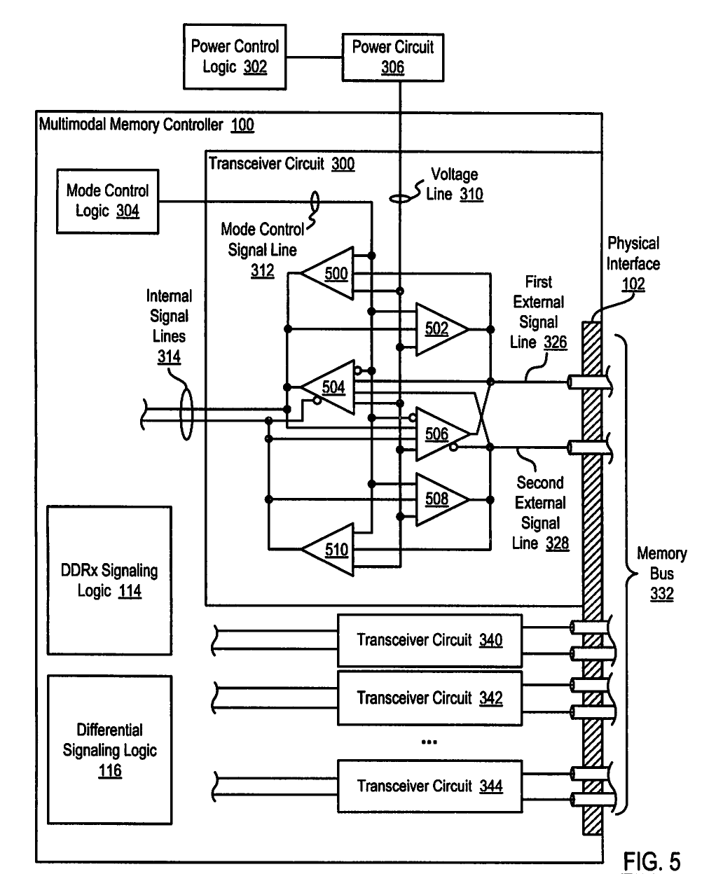

As mentioned above, when operating the external signal lines for single-ended signaling, a transceiver may utilize the external signal lines for bi-directional data communications, and when operating the external signal lines for differential signaling, a transceiver may utilize the external signal lines for uni-directional data communications. In addition, however, a transceiver may also utilize the external signal lines for bi-directional data communications when operating the external signal lines for both differential signaling and single-ended signaling. To perform bi-directional data communications while operating the external signal lines for single-ended signaling and for differential signaling, a multimode memory controller may include both a differential receiver and a differential transmitter along with drivers and receivers used for single-ended signaling. For further explanation, therefore, FIG. 5 sets forth a schematic diagram of a further exemplary multimodal memory controller (100) according to embodiments of the present invention that includes a differential receiver (504) and a differential transmitter (506) along with drivers (502, 508) and receivers (500, 510) used for single-ended signaling.

The multimodal memory controller (100) of FIG. 5 is similar to the multimodal memory controller (100) of FIG. 4. The multimodal memory controller (100) of FIG. 5 includes transceiver circuits (300, 340, 342, 344). Each transceiver circuit connects to a memory bus (332) through a physical interface (102). The transceiver circuit (300) of FIG. 5 has internal signal lines (314), a first external signal line (326), and a second external signal line (328). The internal signal lines (314) connect to DDRx signaling logic (114) and differential signaling logic (116). The external signal lines (326, 328) connect to the memory bus (332) through physical interface (102).

In the example of FIG. 5, the transceiver circuit (300) includes a differential transmitter (506), a differential receiver (504), a first single-ended driver (502), a second single-ended driver (508), a first single-ended receiver (500), and a second single-ended receiver (510). The first single-ended driver (502) and the first single-ended receiver (500) connect to the first external signal line (326) and connect to one of the internal signal lines (314). The second single-ended driver (508) and the second single-ended receiver (510) connect to the second external signal line (328) and connect to the other internal signal line (314). The differential transmitter (506) of FIG. 5 connects to both of the external signal lines (326, 328) and connects to both of the internal signal lines (314). The differential receiver (504) of FIG. 5 connects to both of the external signal lines (326, 328) and connects to both of the internal signal lines (314).

To control whether the transceiver circuit (300) operates the external signal lines (326, 328) for single-ended signaling or operates the external signal lines (326, 328) for differential signaling, the transceiver circuit (300) has a mode control signal line (312). The mode control signal line (312) of FIG. 5 connects mode control logic (118) to enable inputs for the differential receiver (504), the differential transmitter (506), the first single-ended driver (502), the second single-ended driver (508), the first single-ended receiver (500), and the second single-ended receiver (510). The mode control logic (118) of FIG. 5 asserts a mode control signal upon the mode control signal line (312). In the example of FIG. 5, the mode control signal is a binary signal that conveys either a logical one or logical zero to the components of the transceiver (300).

Because the enable inputs for the differential receiver (504) and the differential transmitter (506) complement the mode control signal, the differential receiver (504) and the differential transmitter (506) are disabled while the first single-ended driver (502), the second single-ended driver (508), the first single-ended receiver (500), and the second single-ended receiver (510) are enabled. Similarly, when the differential receiver (504) and the differential transmitter (506) are enabled, the first single-ended driver (502), the second single-ended driver (508), the first single-ended receiver (500), and the second single-ended receiver (510) are disabled. Circuitry within each of the components (500, 502, 504, 506, 508, 510) of the transceiver circuit (300) may disable the component by increasing the impedance of the component to a relatively high value compared to other enabled components, using transistor gates to isolate the disabled component, or in any other manner as will occur to those of skill in the art.

Similar to the example of FIG. 3, the example of FIG. 5 includes a power circuit (306) connected to power control logic (302). The power circuit (306) of FIG. 5 is an electronic circuit that provides power to the components of the transceiver circuit (300) at a plurality of voltages. In the example of FIG. 5, a voltage line (310) provides power at either a first voltage or a second voltage from the power circuit (306) to the first single-ended driver (502), the second single-ended driver (508), the first single-ended receiver (500), the second single-ended receiver (510), the differential receiver (504), and the differential transmitter (506). Using such a voltage configuration along with the configuration of the mode control signal line (312), the transceiver circuit (300) of FIG. 5 is configured to operate the external signal lines (326, 328) for single-ended signaling at a first voltage when the mode control signal is a first value and to operate the external signal lines (326, 328) for differential signaling at a second voltage when the mode control signal is a second value. For example, the transceiver circuit (300) may be configured to operate the external signal lines (326, 328) according to a DDR protocol at 1.8 volts when the mode control signal is logical one and configured to operate the external signal lines (326, 328) according to a packetized, serial protocol at 1.2 volts when the mode control signal is logical zero. Regardless, therefore, of whether the memory bus (332) implements a bus protocol requiring single-ended signaling or differential signaling, the multimodal memory controller is advantageously configured to operate in either mode.

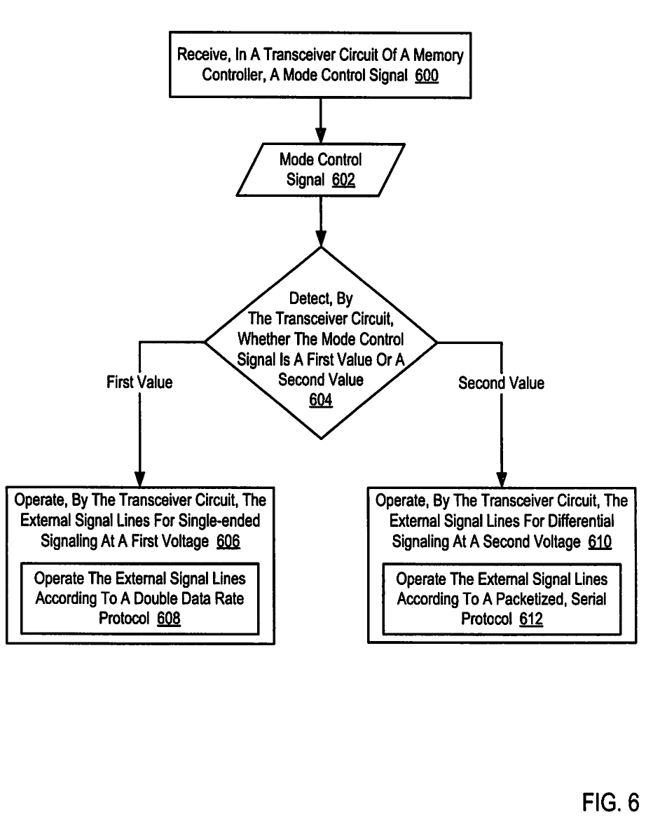

As mentioned above, exemplary methods for multimodal operation of a memory controller in accordance with the present invention are described with reference to the accompanying drawings. For further explanation, therefore, FIG. 6 sets forth a flow chart illustrating an exemplary method of multimodal operation of a memory controller according to embodiments of the present invention. The method of FIG. 6 includes receiving (600), in a transceiver circuit of a memory controller, a mode control signal (602), the transceiver circuit having at least one internal signal line, a first external signal line, and a second external signal line. The mode control single (602) of FIG. 6 represents a binary signal that conveys either a logical one or logical zero to the components of a transceiver.

The method of FIG. 6 also includes detecting (604), by the transceiver circuit, whether the mode control signal (602) is a first value or a second value. The transceiver circuit may detect (604) whether the mode control signal (602) is a first value or a second value according to the method of FIG. 6 by using a voltage comparator to compare the mode control signal to predetermined voltage thresholds that indicate the value for the voltage of the mode control signal (602).

The method of FIG. 6 also includes operating (606), by the transceiver circuit, the external signal lines for single-ended signaling at a first voltage if the mode control signal (602) is a first value. Operating (606), by the transceiver circuit, the external signal lines for single-ended signaling at a first voltage according to the method of FIG. 6 includes operating (608) the external signal lines according to a Double Data Rate protocol such as, for example, the DDR2 protocol or the DDR3 protocol.

The method of FIG. 6 also includes operating (610), by the transceiver circuit, the external signal lines for differential signaling at a second voltage if the mode control signal (602) is a second value. Operating (610), by the transceiver circuit, the external signal lines for differential signaling at a second voltage according to the method of FIG. 6 includes operating (612) the external signal lines according to a packetized, serial protocol such as, for example, the FBDIMM protocol.

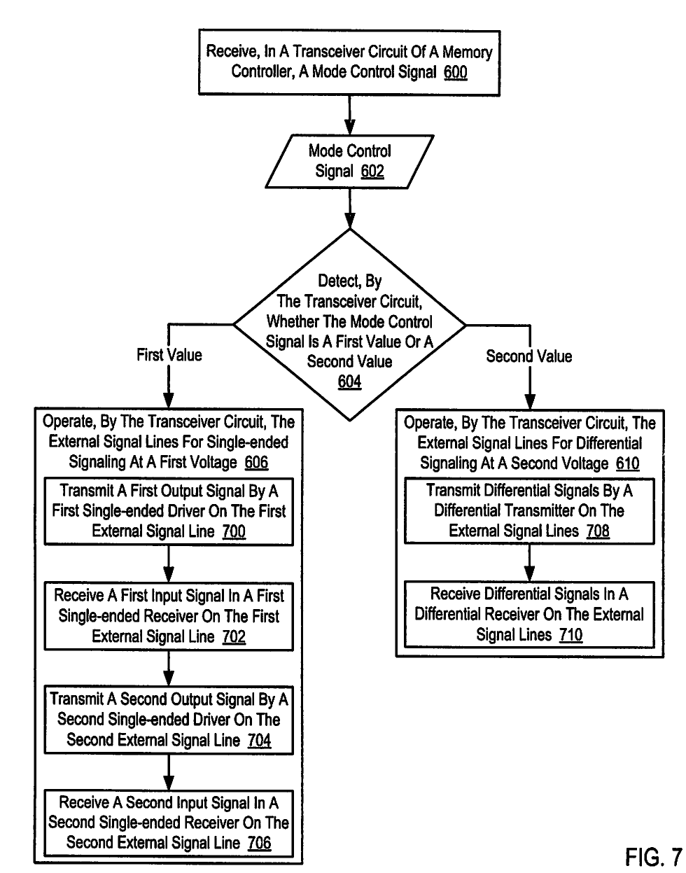

For further explanation of exemplary embodiments the present invention, FIG. 7 sets forth a flow chart illustrating a further exemplary method of multimodal operation of a memory controller according to embodiments of the present invention. The method of FIG. 7 is similar to the method of FIG. 6. That is, the method of FIG. 7 includes receiving (600), in a transceiver circuit of a memory controller, a mode control signal (602), the transceiver circuit having at least one internal signal line, a first external signal line, and a second external signal line, detecting (604), by the transceiver circuit, whether the mode control signal (602) is a first value or a second value, operating (606), by the transceiver circuit, the external signal lines for single-ended signaling at a first voltage if the mode control signal (602) is a first value, and operating (610), by the transceiver circuit, the external signal lines for differential signaling at a second voltage if the mode control signal (602) is a second value.

In the method of FIG. 7, operating (606), by the transceiver circuit, the external signal lines for single-ended signaling at a first voltage if the mode control signal (602) is a first value includes transmitting (700) a first output signal by a first single-ended driver on the first external signal line and receiving (702) a first input signal in a first single-ended receiver on the first external signal line. Operating (606), by the transceiver circuit, the external signal lines for single-ended signaling at a first voltage if the mode control signal (602) is a first value according to the method of FIG. 7 also includes transmitting (704) a second output signal by a second single-ended driver on the second external signal line, and receiving (706) a second input signal in a second single-ended receiver on the second external signal line.

In the method of FIG. 7, operating (606), by the transceiver circuit, the external signal lines for differential signaling at a second voltage if the mode control signal (602) is a second value includes transmitting (708) differential signals by a differential transmitter on the external signal lines. Operating (606), by the transceiver circuit, the external signal lines for differential signaling at a second voltage if the mode control signal (602) is a second value according to the method of FIG. 7 also includes receiving (710) differential signals in a differential receiver on the external signal lines.

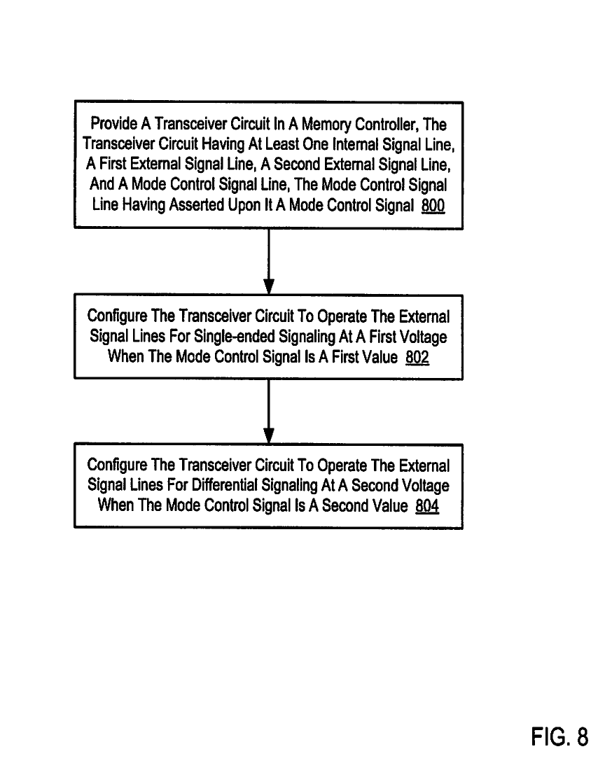

For further explanation of exemplary embodiments the present invention, FIG. 8 sets forth a flow chart illustrating a further exemplary method of multimodal operation of a memory controller according to embodiments of the present invention. The method of FIG. 8 includes providing (800) a transceiver circuit in a memory controller, the transceiver circuit having at least one internal signal line, a first external signal line, a second external signal line, and a mode control signal line, the mode control signal line having asserted upon it a mode control signal.

The method of FIG. 8 also includes configuring (802) the transceiver circuit to operate the external signal lines for single-ended signaling at a first voltage when the mode control signal is a first value. Configuring (802) the transceiver circuit to operate the external signal lines for single-ended signaling at a first voltage when the mode control signal is a first value according to the method of FIG. 8 may be carried out by configuring the transceiver circuit to operate the external signal lines according to a Double Data Rate protocol such as, for example, the DDR2 protocol or the DDR3 protocol.

The method of FIG. 8 also includes configuring (804) the transceiver circuit to operate the external signal lines for differential signaling at a second voltage when the mode control signal is a second value. Configuring (804) the transceiver circuit to operate the external signal lines for differential signaling at a second voltage when the mode control signal is a second value according to the method of FIG. 8 may be carried out by configuring the transceiver circuit to operate the external signal lines according to a packetized, serial protocol such as, for example, the FBDIMM protocol.

In view of the explanations set forth above, readers will recognize that the benefits of multimodal memory controllers according to embodiments of the present invention include:
the same memory controller may be utilized with computer memory buses architectures that implement both a DDRx bus protocol and a packetized, serial bus protocol,
the same socket installed on a motherboard may be used for memory controllers that control a DDRx computer memory bus and a packetized, serial computer memory bus, and
system designers need only design one memory controller for both low end and high end computer systems.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A multimodal memory controller comprising:
a transceiver circuit having at least one internal signal line, a first external signal line, a second external signal line, and a mode control signal line,
the mode control signal line having asserted upon it a mode control signal, and
the transceiver circuit configured to operate the external signal lines for single-ended signaling at a first voltage when the mode control signal is a first value and to operate the external signal lines for differential signaling at a second voltage when the mode control signal is a second value.

2. The multimodal memory controller of claim 1 wherein the transceiver circuit is configured to operate the external signal lines according to a Double Data Rate bus protocol when the mode control signal is the first value.

3. The multimodal memory controller of claim 1 wherein the transceiver circuit is configured to operate the external signal lines according to a packetized, serial bus protocol when the mode control signal is the second value.

4. The multimodal memory controller of claim 1 wherein the transceiver circuit further comprises a differential transmitter/bi-directional circuit, the differential transmitter/bi-directional circuit having a differential transmitter, a first single-ended driver, a second single-ended driver, a first single-ended receiver, and a second single-ended receiver,
the first single-ended driver and the first single-ended receiver connected to the first external signal line,
the second single-ended driver and the second single-ended receiver connected to the second external signal line, and
the differential transmitter connected to both of the external signal lines.

5. The multimodal memory controller of claim 4 wherein the mode control signal line is connected to the differential transmitter, the first single-ended driver, the second single-ended driver, the first single-ended receiver, and the second single-ended receiver.

6. The multimodal memory controller of claim 1 wherein the transceiver circuit further comprises a differential receiver/bi-directional circuit, the differential receiver/bi-directional circuit having a differential receiver, a first single-ended driver, a second single-ended driver, a first single-ended receiver, and a second single-ended receiver,
the first single-ended driver and the first single-ended receiver connected to the first external signal line,
the second single-ended driver and the second single-ended receiver connected to the second external signal line, and
the differential receiver connected to both of the external signal lines.

7. The multimodal memory controller of claim 6 wherein the mode control signal line is connected to the differential receiver, the first single-ended driver, the second single-ended driver, the first single-ended receiver, and the second single-ended receiver.

8. The multimodal memory controller of claim 1 wherein the transceiver circuit further comprises a differential transmitter, a differential receiver, a first single-ended driver, a second single-ended driver, a first single-ended receiver, and a second single-ended receiver,
the first single-ended driver and the first single-ended receiver connected to the first external signal line,
the second single-ended driver and the second single-ended receiver connected to the second external signal line,
the differential transmitter connected to both of the external signal lines, and
the differential receiver connected to both of the external signal lines.

9. The multimodal memory controller of claim 8 wherein the mode control signal line is connected to the differential transmitter, the differential receiver, the first single-ended driver, the second single-ended driver, the first single-ended receiver, and the second single-ended receiver

10. A method of multimodal operation of a memory controller, the method comprising:
receiving, in a transceiver circuit of a memory controller, a mode control signal, the transceiver circuit having at least one internal signal line, a first external signal line, and a second external signal line;
detecting, by the transceiver circuit, whether the mode control signal is a first value or a second value;
operating, by the transceiver circuit, the external signal lines for single-ended signaling at a first voltage if the mode control signal is a first value; and
operating, by the transceiver circuit, the external signal lines for differential signaling at a second voltage if the mode control signal is a second value.

11. The method of claim 10 wherein operating, by the transceiver circuit, the external signal lines for single-ended signaling at a first voltage if the mode control signal is a first value further comprises operating the external signal lines according to a Double Data Rate bus protocol.

12. The method of claim 10 wherein operating, by the transceiver circuit, the external signal lines for differential signaling at a second voltage if the mode control signal is a second value further comprises operating the external signal lines according to a packetized, serial bus protocol.

13. The method of claim 10 wherein operating, by the transceiver circuit, the external signal lines for single-ended signaling at a first voltage if the mode control signal is a first value further comprises:
transmitting a first output signal by a first single-ended driver on the first external signal line;
receiving a first input signal in a first single-ended receiver on the first external signal line;
transmitting a second output signal by a second single-ended driver on the second external signal line; and
receiving a second input signal in a second single-ended receiver on the second external signal line.

14. The method of claim 10 wherein operating, by the transceiver circuit, the external signal lines for differential signaling at a second voltage if the mode control signal is a second value further comprises transmitting differential signals by a differential transmitter on the external signal lines.

15. The method of claim 10 wherein operating, by the transceiver circuit, the external signal lines for differential signaling at a second voltage if the mode control signal is a second value further comprises receiving (710) differential signals in a differential receiver on the external signal lines.

16. A method of multimodal operation of a memory controller, the method comprising:
providing a transceiver circuit in a memory controller, the transceiver circuit having at least one internal signal line, a first external signal line, a second external signal line, and a mode control signal line, the mode control signal line having asserted upon it a mode control signal;
configuring the transceiver circuit to operate the external signal lines for single-ended signaling at a first voltage when the mode control signal is a first value; and
configuring the transceiver circuit to operate the external signal lines for differential signaling at a second voltage when the mode control signal is a second value.

17. The method of claim 16 wherein configuring the transceiver circuit to operate the external signal lines for single-ended signaling at a first voltage when the mode control signal is a first value further comprises configuring the transceiver circuit to operate the external signal lines according to a Double Data Rate bus protocol.

18. The method of claim 16 wherein configuring the transceiver circuit to operate the external signal lines for differential signaling at a second voltage when the mode control signal is a second value further comprises configuring the transceiver circuit to operate the external signal lines according to a packetized, serial bus protocol.
